(19) United States
(12) Patent Application Publication
(10) Pub. No.: US 2011/0246889 A1
(43) Pub. Date: Oct. 6, 2011

(54) STATISTICAL AND VISUAL SPORTS ANALYSIS SYSTEM

(76) Inventor: Herman Moore, Rochester Hills, MI (US)

(21) Appl. No.: 12/998,855

(22) PCT Filed: Dec. 10, 2009
(86) PCT No.: PCT/US2009/067476

§ 371 Date: Jun. 9, 2011

Related U.S. Application Data
(62) Division of application No. 61/121,440, filed on Dec. 10, 2008.

(51) Int. Cl. G06F 17/30; G06F 3/00

(52) U.S. Cl. 715/719; 707/769; 707/E17.014

(57) ABSTRACT

A system for the capturing, storing, searching and display of statistical, textual and visual sports information of both players and teams across a wide spectrum of game situations is described. A user can search through an enormous amount of stored statistical and visual information to find highly specific information about a particular player, team, or game situation involving a particular player and/or team. A series of search drill down menus allows the user to very quickly and easily go sequentially through a number of search result options to find the particular piece (or pieces) of information being sought, whether it is statistical or visual in nature, about a particular player, team, or game situation. Information regarding the search result is also simultaneously displayed with the corresponding text and visual information, which allows the user to put the particular play or player act into proper context.

### CROSS-REFERENCE TO RELATED APPLICATION

The instant application claims priority to U.S. Provisional Patent Application Ser. No. 61/121,440, filed Dec. 10, 2008, pending, the entire specification of which is expressly incorporated herein by reference.

### FIELD OF THE INVENTION

The present invention relates generally to sports and more specifically to a new and improved system for the capturing, storing, searching and display of statistical, textual and visual sports information of both players and teams across a wide spectrum of game situations.

### BACKGROUND OF THE INVENTION

The use of statistical analyses and film/video/digital recordings of sports player performances have greatly enhanced the ability of sports professionals (e.g., owners, general managers, managers, coaches and so forth), amateur sports organizations (e.g., colleges, high schools and so forth), and the general public as well, to have a greater understanding and appreciation of the relative skill and performance levels of particular players, whether they be football players, baseball players, basketball players, hockey players, soccer players and so forth, as well as those teams that the particular players are associated with.

Typically, basic statistics have been kept by professional and/or amateur team officials, or, as is the trend recently, by professional sports statistics services (e.g., Elias Sports Bureau, STATS and/or the like) which provide much more detailed statistical totals and analyses, typically for a fee. The growth of fantasy sports leagues has also lead to an increased demand in more and more detailed statistical services that can break down player or team performance statistics in either several provider-defined or user-defined game situations. By having this information available to them, team officials, as well as fantasy league participants can make more informed decisions on player personnel selection, as well as pre-game and in-game strategy.

Because statistics represent only a portion of evaluating player or team performance, the use of film/videotape/digital technology to capture/record and review practice and game actions has become much more widespread, even down to the intermediate school and high school levels. However, current use of this technology typically involves recording and reviewing isolated game plays without any context to the particular game situation or the specific players involved on both teams. Even superimposing this information onto the film, videotape or digital display does not allow the user to then easily and immediately switch or toggle to other plays involving a particular player or game situation. Thus, the viewer has to go through an enormous amount of film, videotape or digital replays, whether they are raw or annotated, in order to obtain the desired information about a particular player or team performance.

Therefore, it would be advantageous to provide a new and improved system for the capturing, storing, searching and display of statistical, textual and visual sports information of both players and teams across a wide spectrum of game situations that overcomes at least one of the aforementioned problems.

### SUMMARY OF THE INVENTION

In accordance with the general teachings of the present invention, a new and improved system is provided for the capturing, storing, searching and display of both statistical and visual sports information of both players and teams across a wide spectrum of game situations. In this manner, a user, whether they be a highly experienced sports professional or a rank amateur, can easily and quickly search through an enormous amount of stored statistical and visual information to find highly specific information about a particular player, team, or game situations involving a particular player and/or team.

In accordance with one aspect of the present invention, the system of the present invention employs a drill down methodology wherein all pertinent statistical and/or visual information regarding a particular player, team, or game situation involving a particular player and/or team is appropriately tagged or categorized and stored in a searchable database. A series of search drill down menus allows the user to very quickly and easily go sequentially through a number of search result options to find the particular piece (or pieces) of information being sought, whether it is statistical or visual in nature, about a particular player, team, or game situation involving a particular player and/or team. Additionally, highly relevant game situation information regarding the search result is also simultaneously displayed with the text and visual information, which allows the user to put the particular play or player act into proper context. The system can be used on both wired (e.g., desktop computer, cable television, satellite television and so forth) and/or wireless (e.g., wireless computer (e.g., laptop, notebook and so forth), cell phone, smartphone, personal digital assistant (PDA) and so forth) viewing systems, thus the user can access the particular information being sought from any location and at any time. Additionally, the system of the present invention can be Web-based (e.g., accessed through the Internet and/or the like) or it can be part of a stand-alone system (e.g., based on DVD, CD-ROM, computer disk, and/or the like).

In accordance with one embodiment of the present invention, a sports performance analysis system is provided, comprising: (1) a source of player or team performance data; (2) a source of player or team performance video clips, wherein at least a portion of the player or team performance data is linked to at least a portion of the player or team performance video clips; and (3) a search system selectively operable to search at least one player or team performance criterion of the player or team performance data so as to produce a search result.

In accordance with an alternative embodiment of the present invention, a method for providing a sports performance analysis system is provided, comprising: (1) providing a source of player or team performance data; (2) providing a source of player or team performance video clips, wherein at least a portion of the player or team performance data is linked to at least a portion of the player or team performance video clips; and (3) providing a search system selectively operable to search at least one player or team performance criterion of the player or team performance data so as to produce a search result.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic illustration of a flowchart for the uploading and tagging of statistical and visual files to a data storage system, in accordance with a first embodiment of the present invention;

FIG. 2 is an illustration of a first screen shot from an uploader sub-system, in accordance with a second embodiment of the present invention;

FIG. 3 is an illustration of a second screen shot from an uploader sub-system, in accordance with a third embodiment of the present invention;

FIG. 4 is an illustration of a third screen shot from an uploader sub-system, in accordance with a fourth embodiment of the present invention;

FIG. 5 is an illustration of a fourth screen shot from an uploader sub-system, in accordance with a fifth embodiment of the present invention;

FIG. 6 is an illustration of a first screen shot from a web site sub-system, in accordance with a sixth embodiment of the present invention;

FIG. 7 is an illustration of a second screen shot from a web site sub-system, in accordance with a seventh embodiment of the present invention;

FIG. 8 is an illustration of a third screen shot from a web site sub-system, in accordance with an eighth embodiment of the present invention;

FIG. 9 is an illustration of a fourth screen shot from a web site sub-system, in accordance with a ninth embodiment of the present invention;

FIG. 10 is an illustration of a fifth screen shot from a web site sub-system, in accordance with a tenth embodiment of the present invention;

FIG. 11 is an illustration of a sixth screen shot from a web site sub-system, in accordance with an eleventh embodiment of the present invention;

FIG. 12 is an illustration of a seventh screen shot from a web site sub-system, in accordance with a twelfth embodiment of the present invention;

FIG. 13 is an illustration of an eighth screen shot from a web site sub-system, in accordance with a thirteenth embodiment of the present invention;

FIG. 14 is an illustration of a ninth screen shot from a web site sub-system, in accordance with a fourteenth embodiment of the present invention;

FIG. 15 is an illustration of a tenth screen shot from a web site sub-system, in accordance with a fifteenth embodiment of the present invention;

FIG. 16 is an illustration of an eleventh screen shot from a web site sub-system, in accordance with a sixteenth embodiment of the present invention;

FIG. 17 is an illustration of a twelfth screen shot from a web site sub-system, in accordance with a seventeenth embodiment of the present invention;

FIG. 18 is a schematic illustration of a system for the capturing, storing, searching and display of both statistical and visual sports information of both players and teams across a wide spectrum of game situations, in accordance with an eighteenth embodiment of the present invention; and

FIG. 19 is a schematic illustration of an end user access system for accessing and viewing the statistical and visual sports information of both players and teams across a wide spectrum of game situations, in accordance with a nineteenth embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

The present invention includes a system for creating a data storage system (e.g., a database, server and/or the like) for use in the uploading, storing, identifying and retrieving of sports-based visual clips (which can be in the form of video, film, digital recordings, and/or the like) as well as any corresponding statistical and/or textual information. For the purposes of brevity, the term “video clips” will be used to refer to any visual image clips, whether it is based on videotape, film, digital recordings, and/or the like. Although the examples in the following description relate specifically to football, it should be appreciated that the present invention is equally applicable to many different sports.

In accordance with one aspect of the present invention, the system can include three major sub-systems: (1) the data administration or “uploader” sub-system, that is used to create, compress and/or tag data, and then upload it to a game/play information database and/or video clip server; (2) the actual database and data modification processes or “database” sub-system, that can reside on a central server; and (3) the end user application or the “web site” sub-system, that also includes the actual server application, data scripts, and the storage of served web pages and scripts.

By way of a non-limiting example, the uploader sub-system can be a desktop application which can run on a personal computer or other data processor, and can be used to view and select video clips of a live and/or prerecorded sporting event. The selected video clips can then be tagged or linked with various attributes to allow retrieval at a later date, e.g., at a web site. In accordance with one aspect of the present invention, a dual screen view can be employed for live or historical video clip capture and playback.

As noted, the uploader sub-system allows for the selection and tagging of video clips. By way of a non-limiting example, the uploader sub-system can be developed in C++ language in the .NET framework, wherein the application interfaces directly with a MySQL server without an application server layer.

The intended functionality of the uploader sub-system includes, without limitation, video selection and compression, data tagging and input, and database uploading. At the start of a session (or any time during the session), the user can select a number of identification tags that are defaulted (although some can be variable or changeable) for each video clip. That is, each video clip can be associated, tagged or linked with a corresponding set of data or information, regardless of source or format. For example, the user will be able to capture video clips of the video input. After each video clip is captured, the end user will select a number of identification tags specific to that particular video clip. By way of a non-limiting example, selectable tags can include, but are not limited to: (1) season (e.g., year, pre-season/regular/playoff/championship, district, regional, state, or Super Bowl/Pro Bowl); (2) date (e.g., day, week, month, year, time, hour, minute, seconds); (3) away team (e.g., selecting team will default team roster); (4) home team (e.g., selecting team will default team roster); (5) venue (e.g., home, away, city, state, nickname, county, team stadium); and/or (6) player, team, down, distance, yardage, field location, court location, drive number, possession, and/or the like.

The uploader sub-system provides tagging functionality that allows the user to be able to assign tags before starting the actual recording action, as well as during the video recording/capturing step. This functionality allows for less time needed to tag a play before, during and/or after a play capture. For example, before starting the recording/capture of a play, the user can input current down and distance, then select the record feature. For example, while recording, the user sees a pass thrown, and immediately selects pass and offensive player #1, sees pass complete, then selects offensive player #2, sees a tackle, then selects defensive player #1, and so on. Accordingly, if a user is well experienced with the tagging process, they may prefer to assign tags as action is happening, but they can always have the option of waiting until the play ends and recording/capturing has finished.

When a user assigns one or more tags using the uploader sub-system, it instantly creates and assembles a logical, precise, and highly detailed description of the captured subject matter. By way of a non-limiting example, the tags or “play specific information” that could be assigned to a particular video clip can include: (1) time of clip (e.g., defaulted for live video input) for sequencing plays (it should be noted that the time coded clips should not try to reflect actual game time, because it will not necessarily be synchronized); (2) drive number of the current possession; (3) play sequence number; (4) team name, player position, player jersey number; player name, play type (however, player could have multiple play types and yards gained or lost); (5) player name, play type; (6) current down, current distance to go, current position (e.g., yard line); (7) yards gained or lost on the play; and/or (8) yards to 1^{st} down/goal before the play. Of course, it should be noted that dozens, hundreds, or even thousands of player or team performance parameters can be incorporated into the system of the present invention.

Additionally, as previously noted, it should be appreciated that the above examples are specific to football and it should therefore be realized that they would change based on other sports applications.

By way of a non-limiting example, each tag could be selected by a radio-style button, drill down menu, drop-down menu, AJAX menu, or pre-loaded or limited selections to assist the user in consistently identifying actions or play types. After each video clip is selected and tagged, it is saved to a queue for uploading. After all the video clips are saved, they can be reviewed and modified before the upload process is activated.

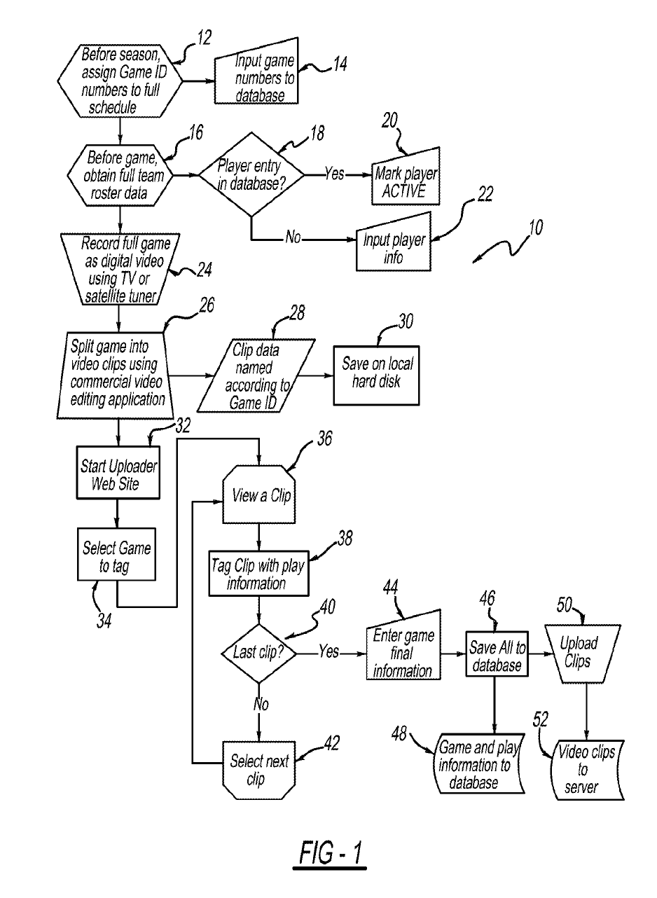

Referring to FIG. 1, an illustrative uploader sub-system is shown generally at 10. It should be noted that one or more of these steps can be optional and that one or more of these steps can be rearranged relative to one another.

At step 12, before the sports season begins, game ID numbers are assigned to cover the games of the full season schedule. These ID numbers can then be input/loaded to a database at step 14. At step 16, before each game, the full team roster data is obtained. At decision node 18, it is determined whether the player has a pre-existing entry in the database. If the answer is YES, the player is marked as ACTIVE at step 20. If the answer is NO, the relevant player information is input/loaded to the database at step 22. At step 24, the full game is recorded, e.g., as digital video using a television, a satellite tuner, and/or the like. At step 26, the full game is split into individual video clips using commercially readily available video editing applications. At step 28, the video clip data is named according to the game ID number. At step 30, the individual video clips are stored on a storage data system, such as but not limited to a local hard disk of a computer. At step 32, the uploader web site is started. At step 34, a particular game is selected to tag. At step 36, a particular video clip is viewed (e.g., from the local hard disk). At step 38, the video clip is tagged with play information (i.e., pieces of data, visual, statistical and/or textual are linked to that particular video clip so as to correspond thereto). At decision node 40, it is determined whether the last video clip is encountered. If the answer is NO, the user, at step 42, selects the next video clips and thus the process goes back to step 36 and repeats steps 38 and 40. If the answer is YES, the final game information is entered at step 44. At step 46, all of the game/play information is input/loaded to the database at step 48. At step 50, the tagged video clips are uploaded to the server at step 52.

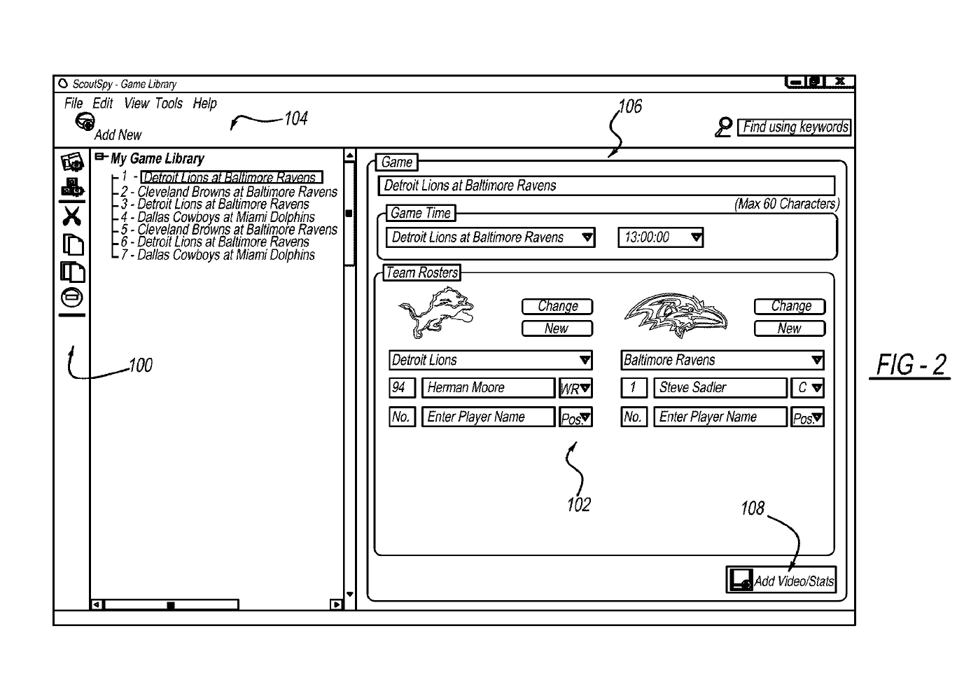

To illustrate how an authorized user (e.g., an administrator) would interface with the uploader sub-system 10, reference is made to FIGS. 2-5.

Referring specifically to FIG. 2, screen shot 100 shows a user interface 102 having a game library menu 104 that allows the authorized user to select a particular game for the purposes of, among other things, selecting individual video clips for tagging with statistical, textual and/or other types of information. In this view, the authorized user has selected a particular game, the details of which are displayed on the major portion of the viewing screen 106 (e.g., a display system). In this view, the two team names, the game date, the game time (shown in 24 hour notation), the team roster menus, individual players names, player uniform numbers, and player positions, are displayed. The option of changing or adding players to the rosters is also provided. At the bottom of the screen, a button 108 is provided that allows the authorized user to add video, textual and/or statistical information to the respective databases/servers, as the case may be.

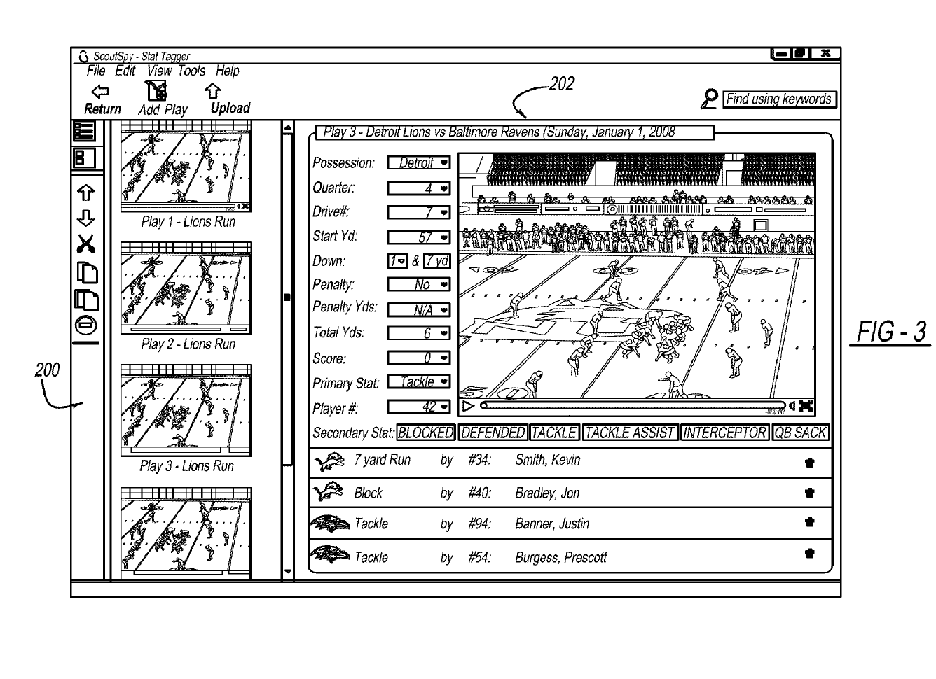

Referring specifically to FIG. 3, screen shot 200 shows a video clip 202 displayed in the major portion of the viewing screen 106. In this view, the authorized user has selected Play 3 from the game depicted in FIG. 2, which causes that corresponding video clip to be displayed. Simultaneously, a number of database fields automatically populate a sub-portion of the major portion of the viewing screen 106. The authorized user can then fill in the fields with the appropriate information, either before viewing the video clip or after viewing the video clip. It should be noted that this tagging process can be accomplished prospectively or in “real time” mode (e.g., as the game is about to begin or has already begun) or retrospectively (e.g., after the game has concluded). In this manner, text and statistical data can be linked with a particular video clip so as to establish a relationship between the various forms of data.

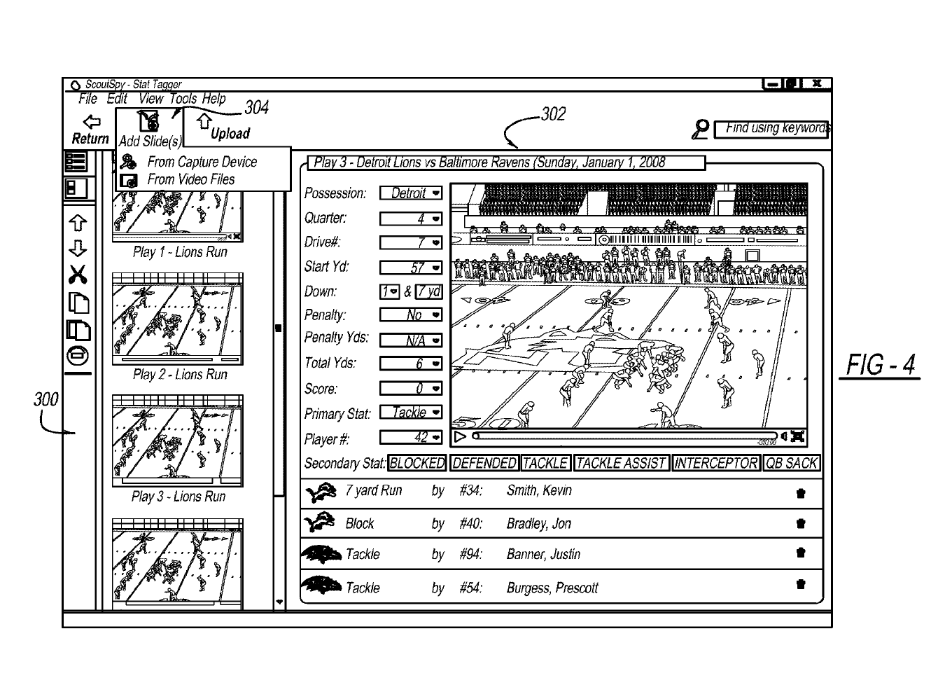

Referring specifically to FIG. 4, screen shot 300 shows a video clip 302 displayed in the major portion of the viewing screen 106. In this view, the authorized user has selected to add the tagged or annotated video clip of Play 3 to its respective database/server, as the tagging process has been completed. This can be accomplished by activating the ADD SLIDE menu button 304 which provides a menu of where to add the slide from, i.e., a capture device (e.g., a digital video recorder) or from the video files (e.g., a data storage device).

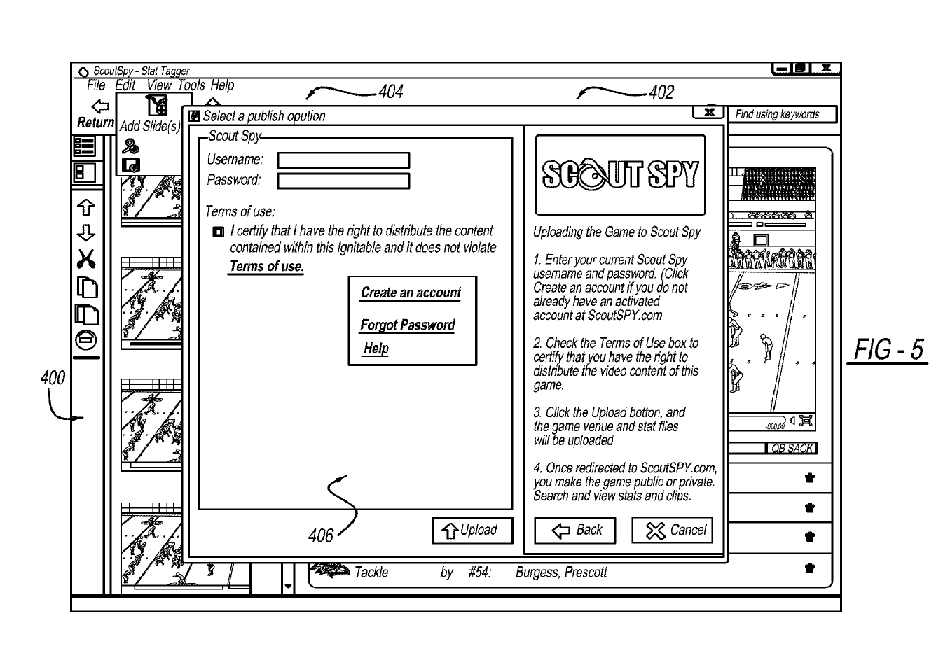

Referring specifically to FIG. 5, screen shot 400 shows a video clip 402 displayed in the major portion of the viewing screen 106. In this view, the authorized user has selected to upload the tagged or annotated video clip of Play 3 to its respective database/server, as the tagging/saving process has been completed. This can be accomplished by activating the UPLOAD menu button 404 which provides an UPLOAD login page 406 for the authorized user to enter appropriate information to ensure the reliability and integrity of the video and/or data being uploaded to the respective databases/servers.

With respect to the database sub-system of the system of the present invention, it should be flexible enough to allow for the many different aspects and outcomes of each sports play, as well as rigid and defined enough to ensure that each possible play type is stored in the same manner to allow for easy searching and retrieval, yet also compact and efficient enough so that the system has good performance, scalability, and usability.

By way of a non-limiting example, a MySQL database server was implemented on a Linux distribution such as Red Hat Enterprise Linux. Using Linux allows for the use of many other external tools to aid in development, as well as provides powerful server-based processing that may be used for other processes, such as video transcoding and/or the like. It also allows for ease in separating server tasks, such as but not limited to locating application servers and SQL servers on different machines. This allows for ease in upscaling processor power. This development platform also provides for easy migration to more robust platforms in the future. Migration to a system such as but not limited to Oracle database running on Sun Microsystems servers would be fairly straightforward, as Linux and MySQL are mostly compatible with the offerings of Solaris (SunOS) and Oracle SQL. However, it should be appreciated that the database sub-system of the system of the present invention can be developed and implemented with any number of different software applications that are readily commercially available.

In accordance with one aspect of the present invention, no data will be allowed to be entered “free-form” during the upload process. All data is to be defined, and various metadata will be provided so that users and administrators can select search criteria or input data. This is required to provide quick and efficient searching, and to ensure that users will be able to find the information that they are looking for.

The database can also contain a selection of static data used for search purposes by users on the web site. The static data can include, without limitation: (1) season data (e.g., games, dates and/or the like); (2) all teams (e.g., plus venues); (3) rosters for all teams; and (4) player height, weight, sport specific test results (e.g., 40 yard dash, vertical jump/leap and/or the like), penalties, states, positions, teams, camps, combines, venues, event types and/or the like).

Additional search criteria for the database can include, without limitation: (1) data dictionary that defines all data objects; (2) database creation scripts; (3) static data creation scripts; (4) metadata creation scripts; and (5) metadata upload/download scripts.

With respect to the web site sub-system of the system of the present invention, this is what the end user uses to interact with the database. Here, the end user will be able to enter various search criteria to structure queries with the end result being a list from which the user can ultimately select videos to view. The web site is intended to be intuitive and easy to use, yet powerful and flexible. The design emphasis presented allows the web site user the ability to perform the most common searches and tasks with a minimum of navigation clicks or keystrokes.

As noted, the database can contain a selection of static data used for search purposes by users on the web site. The static data can include, without limitation: (1) season data (e.g., games, dates and/or the like); (2) all teams (e.g., plus venues); (3) roster for all teams; (4) player height, weight, sport specific test results (e.g., 40 yard dash, vertical jump/leap and/or the like), penalties, states, positions, teams, camps, combines, venue, event type, year, school year, player experience, ratings and/or the like. Again, the above examples represent a small portion of the number of search fields that can be provided to the end user to allow them to “drill down” through an enormous amount of data to locate the exact information they are looking for.

With that in mind, there is provided a method to do advanced searches for those with specific needs by simply allowing the user to type in a known tag criteria or subject matter term or phrase such as “team name,” “player name” (e.g., first or last or both), “city,” and/or “state”. This functionality is provided by using standards compliant web pages, only using the newest technology where required to provide maximum user benefit. By limiting the technologies to standards that are in wide use and highly compatible, maximization is achieved of the platform portability and the system of the present invention can be extended to a wider audience. In this manner, the system of the present invention can be accessed through more Internet-enabled devices, such as mobile phones, mobile Internet tablets, handheld gaming devices, and home gaming consoles.

The web site screens can be constructed using standard HTML 3.2 or 4.0 where applicable, and the database currently uses PHP scripts, but could be changed to include newer coding language like PYTHON. Again, any number of web site software applications can be used to construct and administer the web site sub-system of the system of the present invention.

Based on the input and mockup of the search screens, the system of the present invention employs a “drill down” or “AJAX” method of search screens. The initial search screens can have a basic search feature (e.g., with the immediate option to go to a more full featured “advanced search” page). Once the user selects the basic search criteria and performs the search, his/her results are displayed in a list, with the opportunity to select other criteria to further narrow the search. Selecting the item from the list will show basic data. The basic data displayed is dynamic, because the additional data displayed should not include the search criteria. For instance, if a user has searched on the player name field for “Herman Moore,” there is no need to display “Herman Moore” for each clip in the list. Search criteria is dynamic and instantly modifies based on other user selections. This functionality can be achieved by using Javascript/JScript and AJAX, depending on the amount of data to be managed, but it should be realized that other technologies may be utilized to take into account the large amount of data and the likelihood that most users do not have high speed Internet connections.

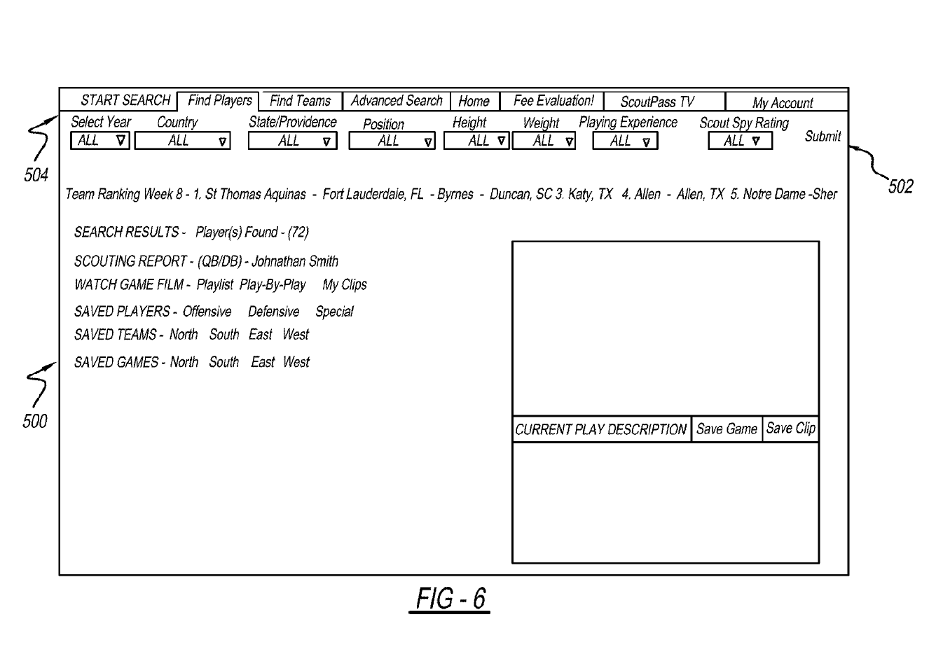

To illustrate how an end user (e.g., a subscriber) would interface with a web site featuring the system of the present invention, reference is made to FIGS. 6-17.

Referring specifically to FIG. 6, screen shot 500 shows a user interface 502 having a START SEARCH menu 504 that allows the end user to select multiple search criteria for the purposes of, among other things, retrieving search results according to a particular search strategy. For example, information concerning which player has the best pass completion percentage in road games, which player has the best yards per reception average when their team is trailing by more than seven points at home, which player has the best run yardage average in short yardage situations in the first quarter, which player has the highest number of run plays in the third quarter of a home game, which player has the worst field goal percentage from 40+ yards out in the fourth quarter of a road game and/or the like, can provide a sports professional, whether they be a general manager, coach, player and/or the like, invaluable information gauging a particular player's (or team's) performance, strengths and weaknesses, and perhaps most importantly, tendencies in any number of given game situations.

Although the following example will relate to retrieving information on particular individual players, it should be noted that the system of the present invention, especially when the drill down menu feature is employed, can retrieve information on team performance as well. For example, information concerning which teams have the best road records, which teams have the worst passing game in terms of yards per pass attempt in road games during the month of November, which teams have the best fourth down percentage in short yardage situations in home games during the fourth quarter, which teams have the highest percentage of run plays on second down in long yardage situations in games they are trailing by 3+ points, which teams have the lowest average number of penalty yards per game and/or the like, can provide a sports professional, whether they be a general manager, coach, player and/or the like, invaluable information gauging a particular team's (or player's) performance, strengths and weaknesses, and perhaps most importantly, tendencies in any number of given game situations.

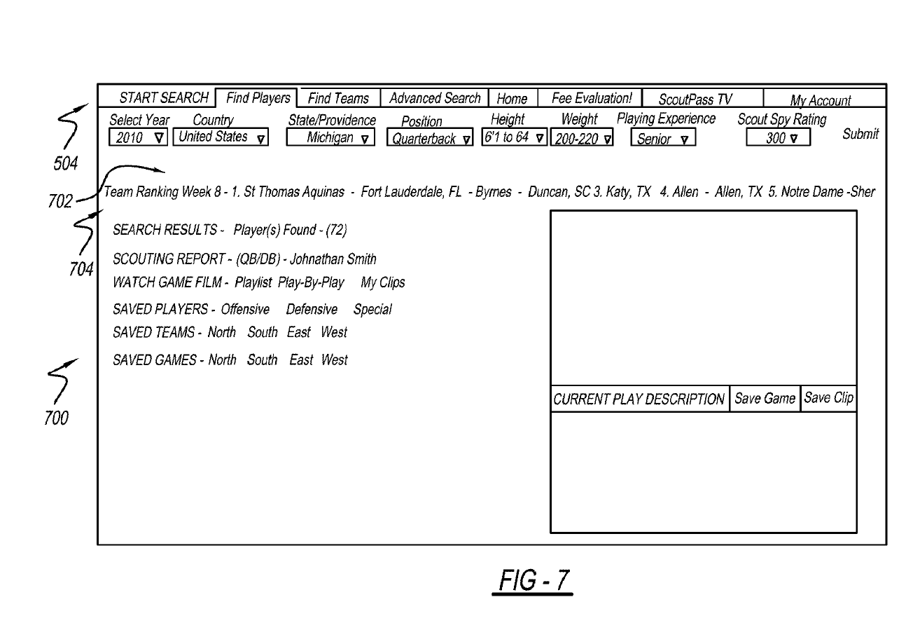

Referring specifically to FIG. 7, screen shot 700 shows the end user selecting multiple search criteria 702 according to a particular search strategy on the START SEARCH menu 504 for the purposes of, among other things, retrieving search results. It should be noted that the end user can search one search field 704 at a time, or multiple search fields at a time, in order to more clearly focus the search. Again, if team performance was being evaluated instead of player performance, a different set of relevant search fields would be displayed.

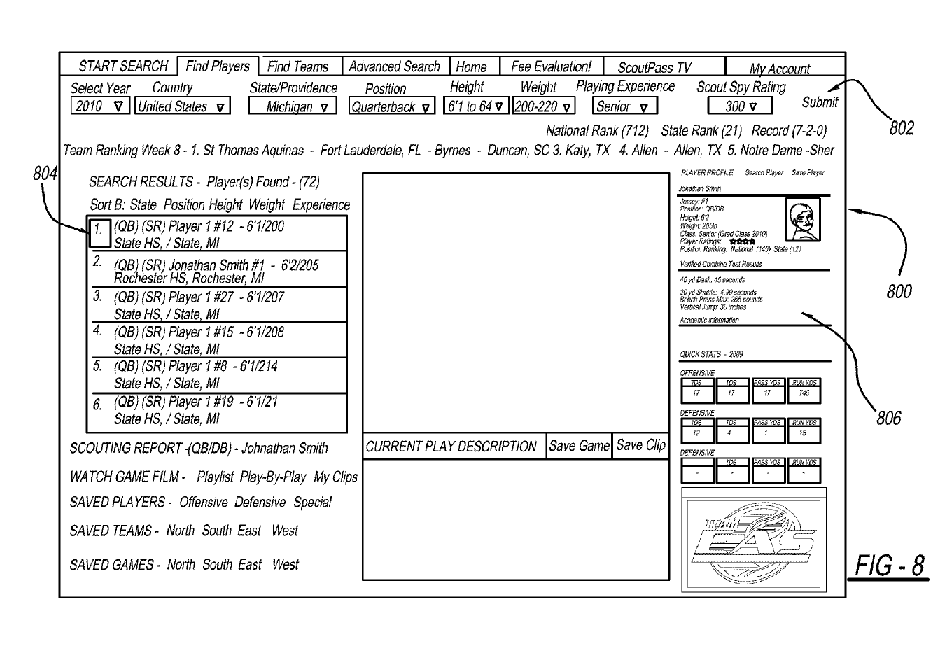

Referring specifically to FIG. 8, screen shot 800 shows the end user having submitted the multiple search criteria (e.g., by actuating the SUBMIT button 802) whereupon the search results are displayed in box 804 under SEARCH RESULTS. Box 804 provides a sortable list of the query request results such that the end user can toggle through any of the individual search results, in this case a list of all Michigan high school quarterbacks having certain physical attributes, experience, and rating levels. When the end user toggles over a particular player, in this case, Jonathan Smith, Mr. Smith's detailed personal, educational and player performance statistics and rankings automatically populate a PLAYER PROFILE box 806, thus allowing the end user to immediately have detailed player performance information without having to navigate to another portion of the web site.

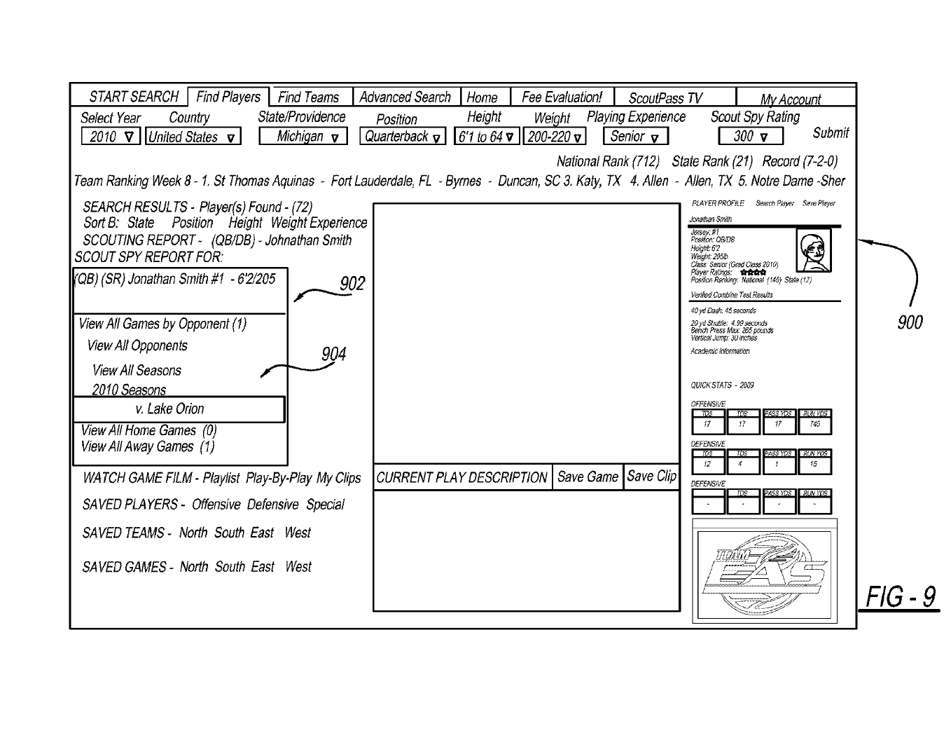

Referring specifically to FIG. 9, screen shot 900 shows the end user accessing the SCOUTING REPORT box 902 that features a drill down menu 904 allowing the end user to see the displayed menu results and to further navigate through the results to find the information or entry he/she is after. In this case, the end user has navigated through the drill down menu 904 to find an entry consisting of a football game that Mr. Smith participated in against Lake Orion high school.

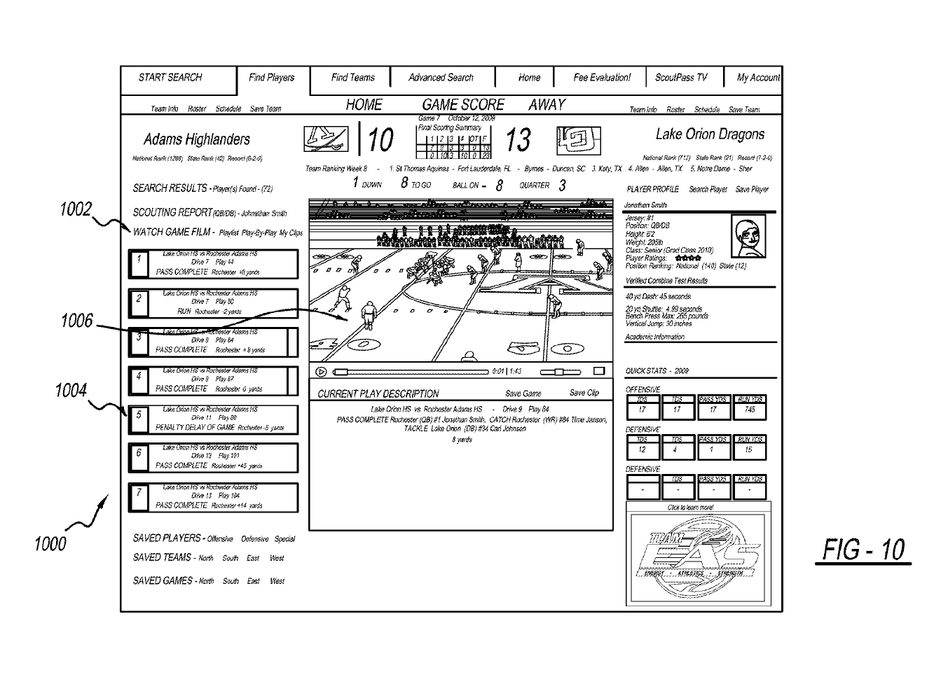

Referring specifically to FIG. 10, screen shot 1000 shows the end user accessing the WATCH GAME FILM box 1002 that features a plurality of video clips 1004 of the football game that Mr. Smith participated in against Lake Orion high school. The video clips 1004 can be numbered according to play number (e.g., 1 and so on) as well as color coded to quickly indicate the type of play depicted (e.g., green for positive yardage play (e.g., completed pass), red for negative yardage play (e.g. loss on a running play), yellow for penalty, gray for zero yardage play (e.g., incomplete pass) and/or the like). It should be appreciated that color coding can also be used in other portions of the web site, e.g., the search fields and/or menus (as well as any search result lists) can also be color coded. More importantly, in this view, when the end user toggles over a particular video clip, in this case, Play 3, the visual and/or audio depiction of that exact play is automatically populated in the video clip viewer 1006, thus allowing the end user to immediately see and hear the actual play that Mr. Smith participated in, rather than having to rely on a mere text or statistical description of the play. It should be noted that any player, offense or defense, that played any role in the play is detailed immediately below the video clip viewer 1006, thus allowing the end user the ability to toggle to that player to learn more about them.

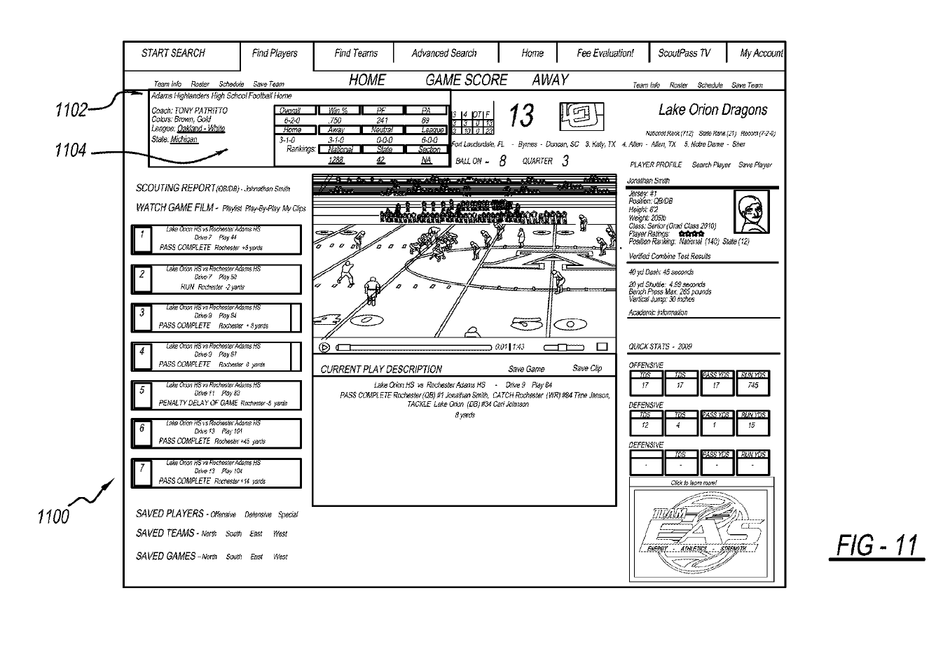

Referring specifically to FIG. 11, screen shot 1100 shows the end user accessing the TEAM INFO box 1102 that features information 1104 about the high school that Mr. Smith plays for allowing the end user to see contact information, school record, rankings and/or the like. Again, all the previously accessed information, including the biographical, statistical, and video clip, remains on the screen while the end user navigates through other portions of the web site.

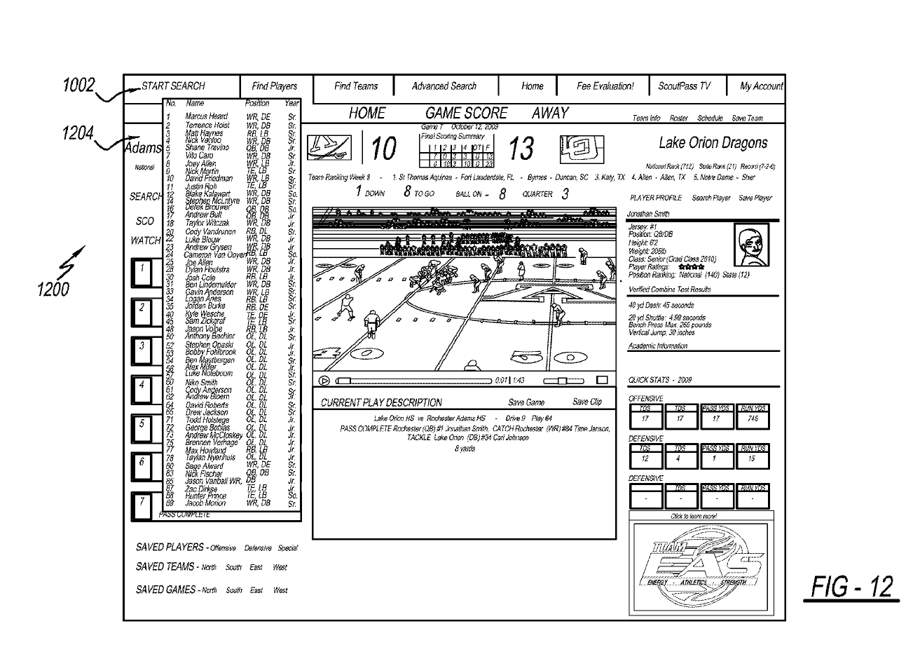

Referring specifically to FIG. 12, screen shot 1200 shows the end user accessing the ROSTER box 1202 that features a drop down menu 1204 of the high school roster that Mr. Smith is a member of. Again, all the previously accessed information, including the biographical, statistical, and video clip, remains on the screen while the end user navigates through other portions of the web site.

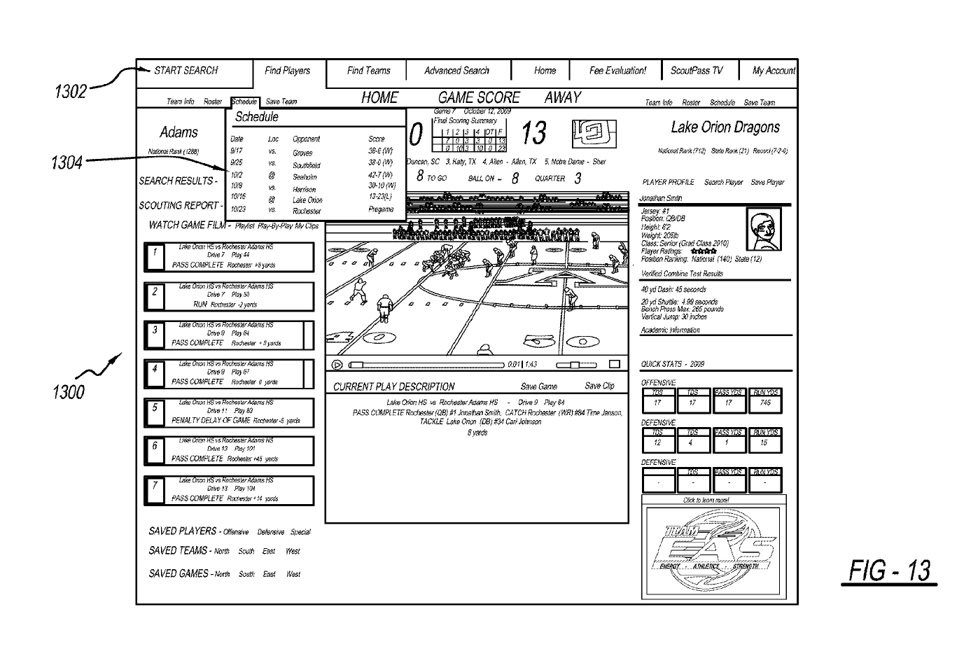

Referring specifically to FIG. 13, screen shot 1300 shows the end user accessing the SCHEDULE box 1302 that features a drop down menu 1304 of the game schedule of the high school that Mr. Smith plays for. Again, all the previously accessed information, including the biographical, statistical, and video clip, remains on the screen while the end user navigates through other portions of the web site.

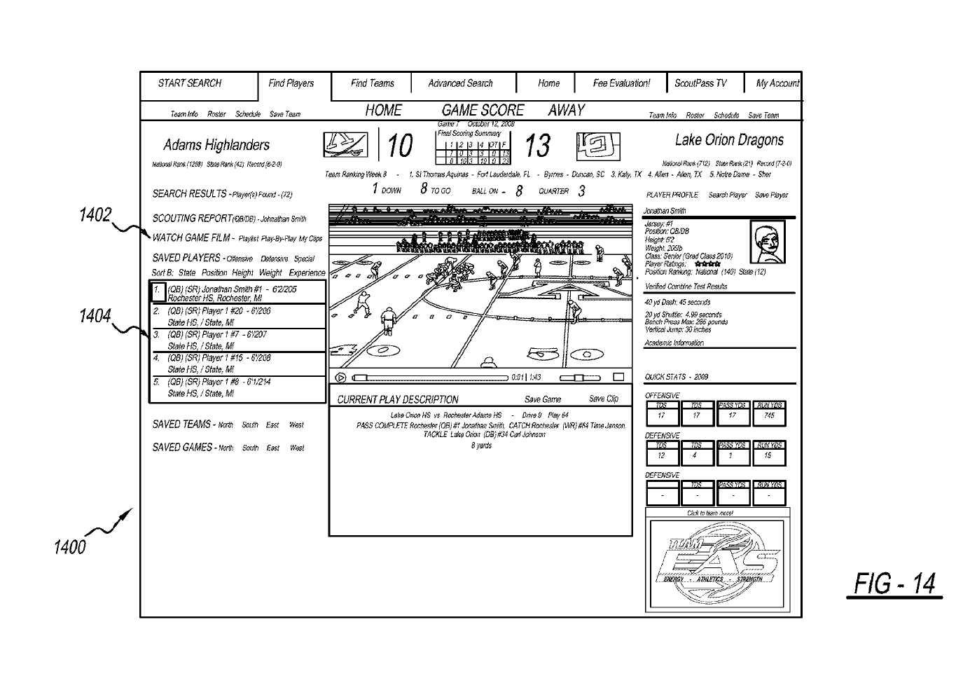

Referring specifically to FIG. 14, screen shot 1400 shows the end user accessing the SAVED PLAYERS box 1402 that features a drop down menu 1404 of the saved players, e.g., from previous searches. Menu 1404 provides a sortable list such that the end user can toggle through any of the individual player names. Again, all the previously accessed information, including the biographical, statistical, and video clip, remains on the screen while the end user navigates through other portions of the web site.

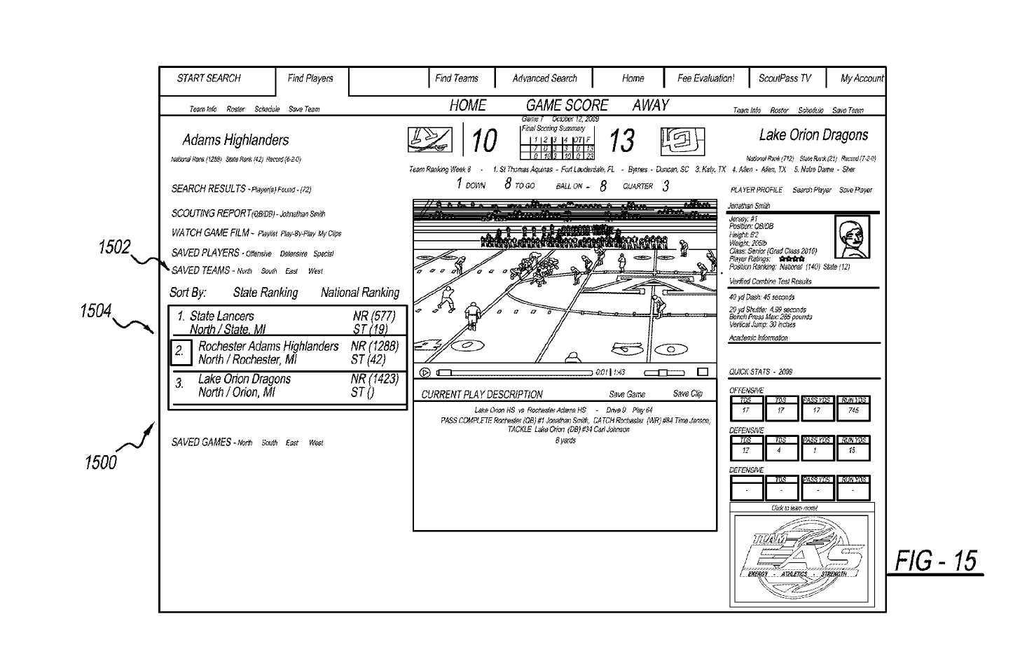

Referring specifically to FIG. 15, screen shot 1500 shows the end user accessing the SAVED TEAMS box 1502 that features a drop down menu 1504 of the saved teams, e.g., from previous searches. Menu 1504 provides a sortable list such that the end user can toggle through any of the individual school team names. Again, all the previously accessed information, including the biographical, statistical, and video clip, remains on the screen while the end user navigates through other portions of the web site.

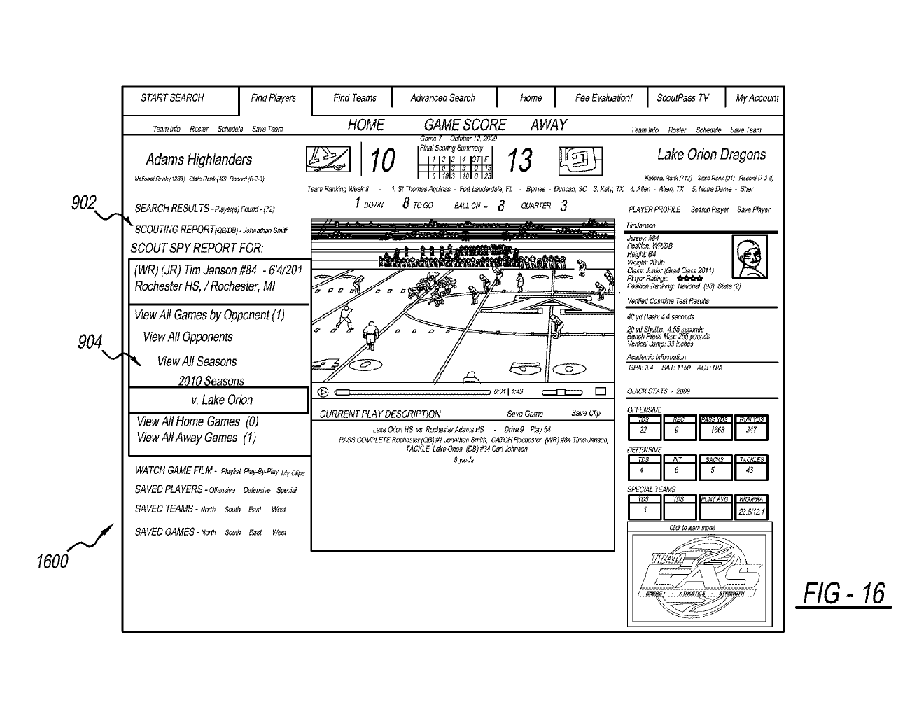

Referring specifically to FIG. 16, screen shot 1600 shows the end user again accessing the SCOUTING REPORT box 902 that features a drill down menu 904 allowing the end user to see the displayed menu results and to further navigate through the results to find the information or entry he/she is after. In this case, the end user has navigated through the drill down menu 904 to find an entry consisting of a football game that Tim Janson (i.e., the wide receiver that Mr. Smith threw and completed a pass to) participated in against Lake Orion high school. Thus the end user, having viewed a video clip, can then easily toggle to any other player involved in the play to see information on them, as previously noted.

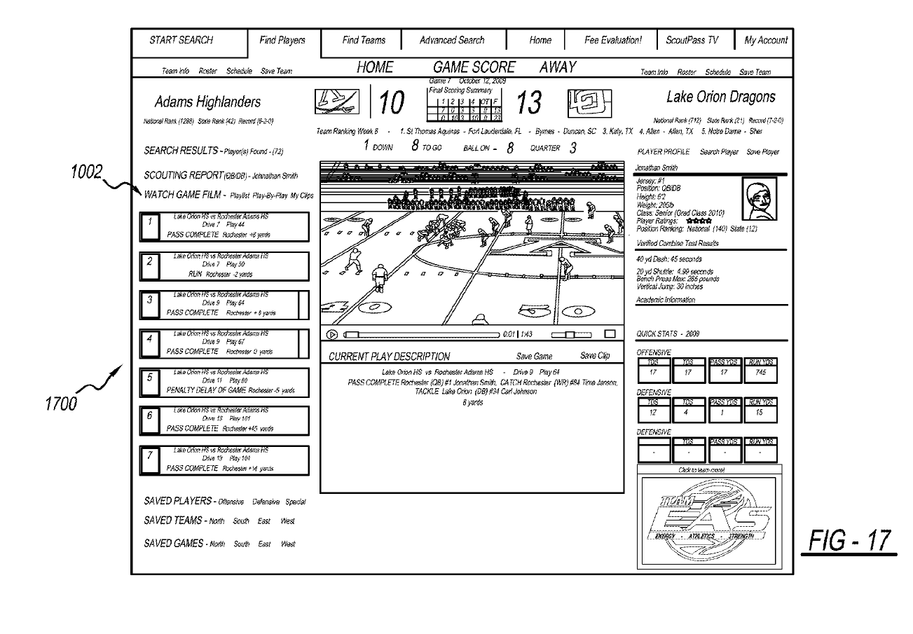

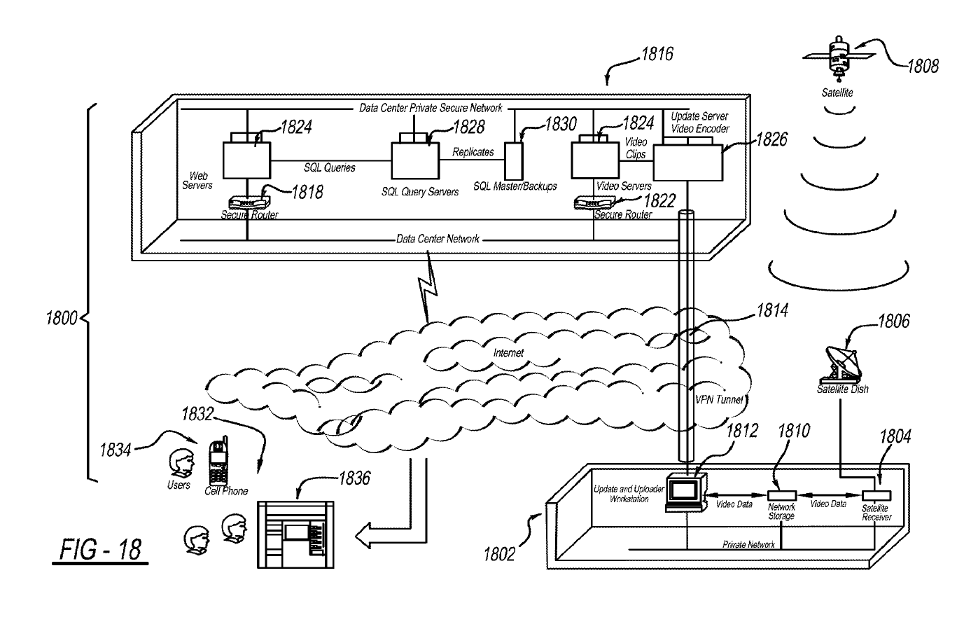

Referring specifically to FIG. 17, screen shot 1700 shows the end user toggling back to the WATCH GAME FILM box 1002 to view more video clips about Mr. Smith. Thus the end user, having viewed information about another player, can then easily toggle back to see more video clips of any other previously viewed player without having to conduct a new search.

Referring to FIG. 18, there is shown an illustrative schematic illustration of a system 1800 for the capturing, storing, searching and display of both statistical and visual sports information of both players and teams across a wide spectrum of game situations. By way of a non-limiting example, the uploader sub-system 1802 includes game video data, e.g., via a satellite broadcast, that is received by a satellite receiver 1804 (via a satellite dish 1806 in communication with a satellite 1808). The game video data is transferred to a network storage device 1810, and then transferred to a workstation 1812 for updating, annotating, tagging, and uploading, e.g., via a VPN tunnel 1814, to a database sub-system 1816. The uploaded data is routed through a secure router 1818 to a web server system 1820 and the uploaded video data is routed through a secure router 1822 to a video server system 1824. The video clips are processed through and update server/video encoder system 1826 and the data queries (e.g., statistical search requests) are processed through a SQL query server system 1828 (which is replicated by a SQL master/backup system 1830). The web site sub-system 1832, permits end users to access the data center network (as opposed to the data center private secure net) via wireless devices 1834 (e.g., cells phones and the like) or wired devices 1836 (e.g., desktop computers with Internet connections) through the Internet 1838 with search requests that will allow the end users to retrieve text, statistics and video clips that are relationally linked.

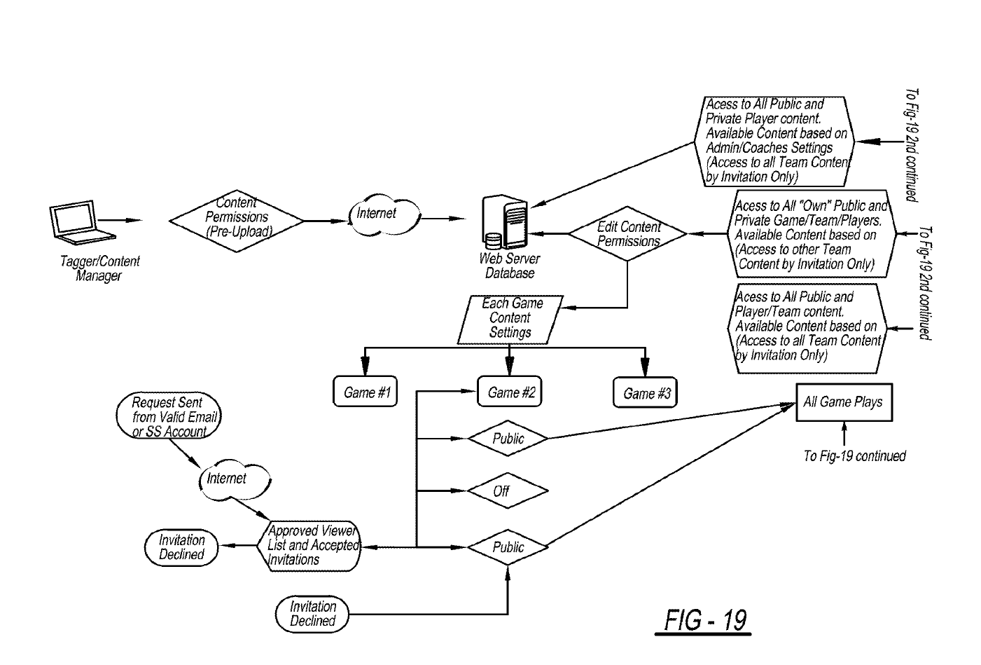

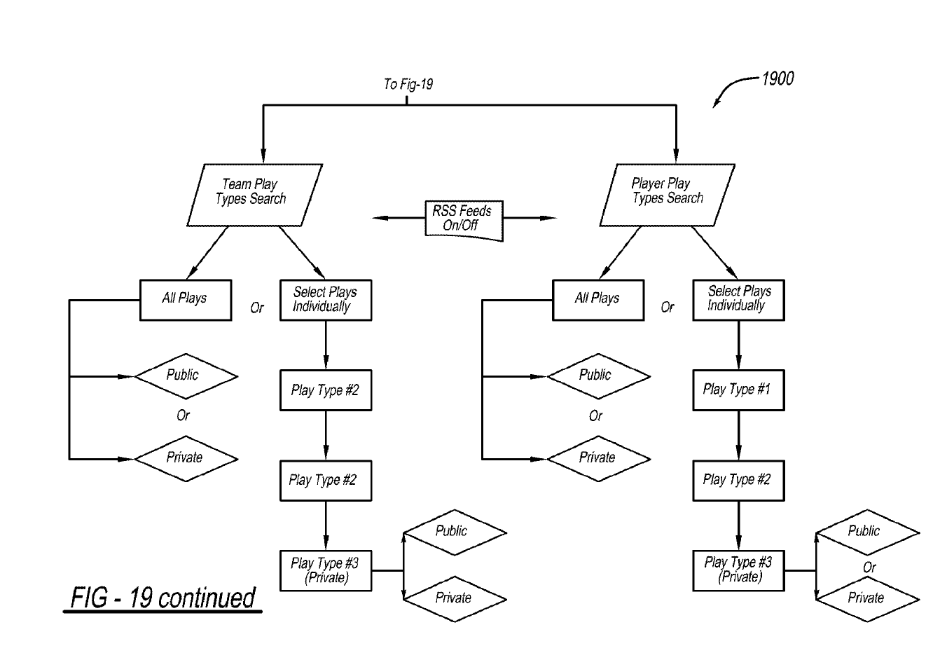

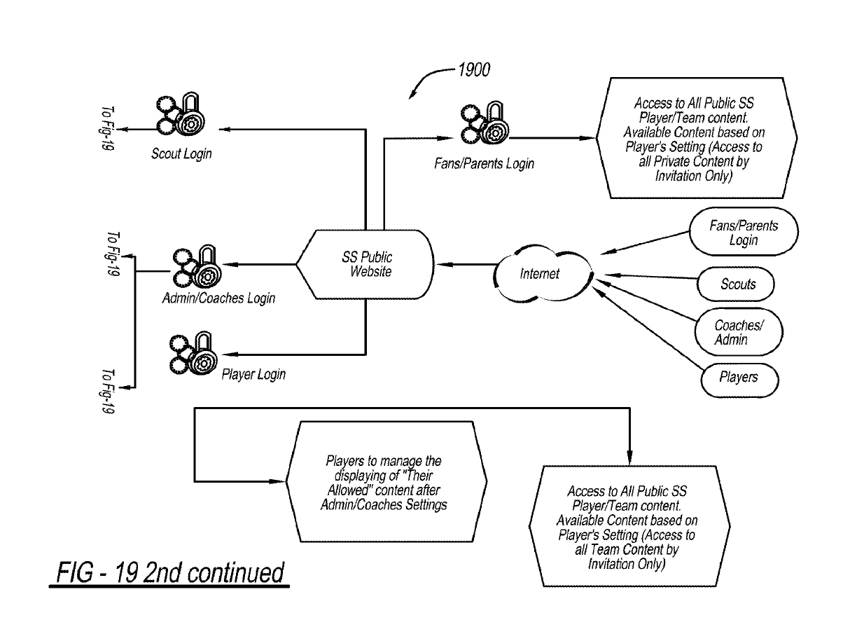

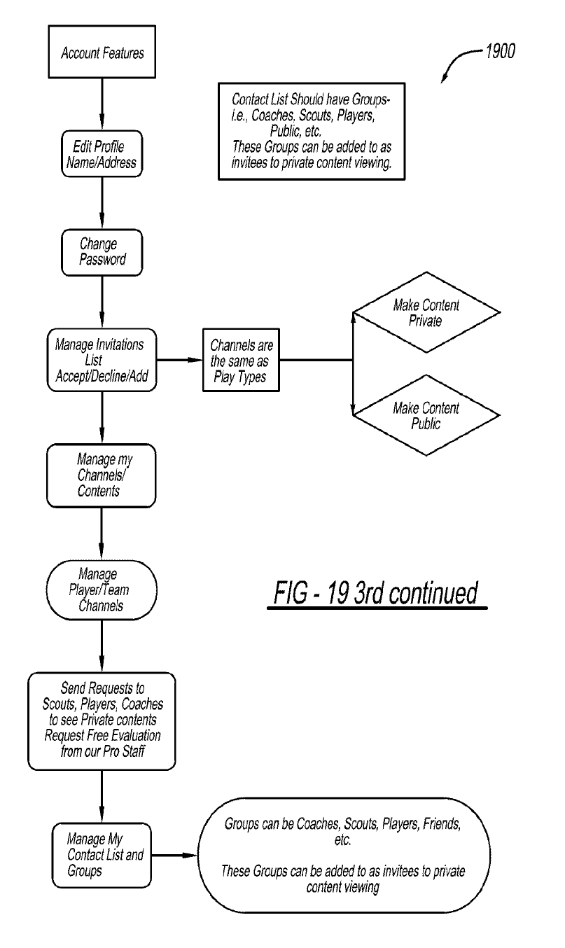

An illustrative example of a schematic for an end user interface or access system 1900 for the data center network of the present invention is shown in FIG. 19. In this view, access to certain features of the system of the present invention can be controlled or limited (e.g., via password or by invitation) based on the end user (e.g., professional sports officials such as coaches, scouts and players have greater access and the general public has less access).

It should be noted that the web portal can be used as a public or private space for users to share video from sporting events in their unedited form or in the individual clip form, but consisting of the entire event, which provides a very effective and cost-saving sharing tool between coaches, players, fans, sports writers, general managers and/or the like.

Additional features of the system of the present invention include video compression. For example, capturing and saving locally on or on an external server/computer a copy of the uncompressed/original video clip size on the fly and transcoding and compressing another copy of the same clip to be uploaded to either instantly or later to the web site, wireless or mobile devices. By capturing and transcoding on the fly, it significantly reduces the upload time and video sizes. Depending on which file is sent to the web server, it will increase the size of the video transfer and storage. The video will be transcoded on the server to various sizes and qualities so that users can select video appropriate for their Internet connection and desires. This system also uses one or more standardized video codecs that will allow users to select multiple available video formats across a wide range of platforms.

Another feature is user accounts and preferences. For example, repeat visitors can save default settings, as well as store favorite searches or preferred teams and players.

Examples of the components used to construct the system of the present invention, include, but are not limited to visual interface design and implementation (this includes design and layout of web pages, Javascript, JScript and HTML coding, and graphic design); application coding (this includes database coding and implementation, database administration, system implementation coding, server side scripting in CGI, C++, PHP, Java, and PERL).

Also envisioned is a screen button that allows a user to export one or more video clips to highlight the creation library/tool within the web site to create personal highlights by using a drag and drop function onto a timeline.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A sports performance analysis system, comprising:
a source of player or team performance data;
a source of player or team performance video clips;
wherein at least a portion of the player or team performance data is linked to at least a portion of the player or team performance video clips; and
a search system selectively operable to search at least one player or team performance criterion of the player or team performance data so as to produce a search result.

2. The invention according to claim 1, further comprising a display system for displaying the search result.

3. The invention according to claim 1, wherein at least one portion of the search result is color coded.

4. The invention according to claim 1, wherein the search result includes at least one drill down menu.

5. The invention according to claim 1, wherein the search result includes at least one player or team identifying indicia and at least one player or team performance video clip.

6. The invention according to claim 5, wherein the at least one player or team identifying indicia and the at least one player or team performance video clip are simultaneously displayed on a display system.

7. The invention according to claim 1, wherein the search system includes a plurality of search fields.

8. The invention according to claim 1, wherein the search system includes at least one drill down menu.

9. The invention according to claim 1, wherein the player or team performance data is selected from the group consisting of biographical, statistical, diagnostic data, and combinations thereof.

10. The invention according to claim 1, wherein the player or team performance data is stored in a data storage system.

11. The invention according to claim 10, wherein the player or team performance video clips are stored in a data storage system.

12. The invention according to claim 11, wherein the data storage system of the player or team performance data and the data storage system of the player or team performance video clips are in communication with one another.

13. A method for providing a sports performance analysis system, comprising:
providing a source of player or team performance data;
providing a source of player or team performance video clips;
wherein at least a portion of the player or team performance data is linked to at least a portion of the player or team performance video clips; and
providing a search system selectively operable to search at least one player or team performance criterion of the player or team performance data so as to produce a search result.

14. The invention according to claim 13, further comprising providing a display system for displaying the search result.

15. The invention according to claim 13, wherein at least one portion of the search result is color coded.

16. The invention according to claim 13, wherein the search result includes at least one drill down menu.

17. The invention according to claim 13, wherein the search result includes at least one player or team identifying indicia and at least one player or team performance video clip.

18. The invention according to claim 17, wherein the at least one player or team identifying indicia and the at least one player or team performance video clip are simultaneously displayed on a display system.

19. The invention according to claim 14, wherein the search system includes a plurality of search fields.

20. The invention according to claim 14, wherein the search system includes at least one drill down menu.

21. The invention according to claim 14, wherein the player or team performance data is selected from the group consisting of biographical, statistical, diagnostic data, and combinations thereof.

22. The invention according to claim 14, wherein the player or team performance data is stored in a data storage system.

23. The invention according to claim 22, wherein the player or team performance video clips are stored in a data storage system.

24. The invention according to claim 23, wherein the data storage system of the player or team performance data and the data storage system of the player or team performance video clips are in communication with one another.
